(19) United States
(12) Patent Application Publication
(10) Pub. No.: US 2004/0211760 A1
(43) Pub. Date: Oct. 28, 2004

(54) Plasma cutting process with dual gas flow

(76) Inventors: Michel Delzenne, Franconville (FR); Edmond Baillot, Montgeroult (FR)

Correspondence Address: Elwood Haynes, Air Liquide, Suite 1800, 2700 Post Oak Blvd., Houston, TX, 77056, US

(21) Appl. No.: 10/798,653

(22) Filed: Mar. 11, 2004

(30) Foreign Application Priority Data
Mar. 18, 2003 (FR) 0303301

(51) Int. Cl. B23K 10/00

(52) U.S. Cl. 219/121.44; 219/121.39; 219/121.51

(57) ABSTRACT

The invention relates to a plasma arc cutting process for cutting a metal workpiece, in which a dual-gas-flow torch fitted with an electrode with an emissive insert is used, the said torch delivering a central gas stream and an annular gas stream, the said annular stream being delivered peripherally to the central gas stream, characterized in that the central gas stream contains a hydrogen-nitrogen mixture and the peripheral gas stream contains carbon dioxide. The invention also relates to a unit comprising such a torch.

The present invention relates to a plasma arc cutting process for cutting a metal workpiece by means of a dual-gas-flow torch fitted with an electrode with an emissive insert, and to a unit comprising such a torch.

The process of cutting structural steels, that is to say non-alloy or low-alloy carbon steels, or even stainless steels and aluminium alloys, by means of a plasma arc in an oxygen atmosphere has been known for many years.

A plasma cutting device capable of implementing such a process generally comprises a plasma cutting torch comprising a nozzle for ejecting the plasma arc towards the workpiece to be cut, an electrode that forms the cathode, placed a certain distance from the nozzle and coaxially therewith, a supply of plasma gas, such as compressed air, oxygen or any other gas mixture containing at least one oxidizing gas, and a means of delivering the plasma gas to the volume separating the electrode from the nozzle, also called a plasma chamber.

The workpiece itself forms the anode, the cathode and the anode being connected to the terminals of a current generator.

Several types of plasma arc cutting processes and torches are widely used in the industry.

Thus, there are torches with a single injection of plasma gas, also called single-flow torches, which deliver a single flow of gas, for example, formed from an oxidizing gas, such as oxygen or a nitrogen-oxygen mixture in proportions that are identical to or different from those of air.

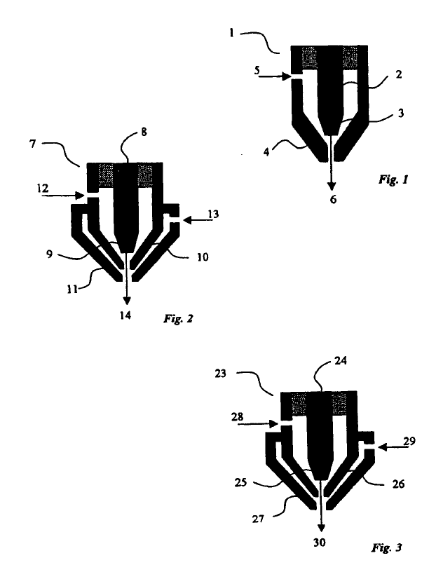

A single-flow torch is shown diagrammatically in FIG. 1. This torch 1 comprises an electrode 2 provided with an emissive insert 3, made of zirconium or hafnium, which is fitted into or crimped onto the end of the body of the electrode 2, a nozzle 4 and one or more gas inlet passages 5 for supplying the plasma chamber bounded by the electrode 2 and the internal wall of the nozzle 4 with an oxidizing plasma gas.

During use of the torch, the plasma arc 6, created in the emissive insert 3, extends from the electrode 2, 3 through the nozzle 4 towards the workpiece to be cut, which is located below the torch (not shown).

Moreover, there are also torches with dual injection of plasma gas, also called dual-flow torches.

A dual-flow torch is shown diagrammatically in FIG. 2. This torch 7 comprises, like that in FIG. 1, an electrode 8 fitted with an emissive insert 9, a first nozzle 10 and a first gas inlet passage 12 for supplying the plasma chamber with a first plasma gas.

However, in this case, the torch 7 also includes a second nozzle 11 and a second passage 13 for supplying a second plasma gas, which may also be an oxidizing gas, for example compressed air, oxygen or a nitrogen-oxygen mixture in proportions other than those of air.

In this case, the plasma arc 14 formed extends from the electrode 8, 9 through the first and second nozzles 10, 11 towards the workpiece (not shown).

The use of these various torches produces cutting results of satisfaction to the industry, but they all have in common the use of electrodes with a very limited lifetime.

This is because, owing to the oxidizing gaseous atmosphere in which the electrode is immersed, the latter must be provided with an emissive zirconium or hafnium element that has only a very limited lifetime, typically about 1 to 4 hours, depending on the number of striking operations or cutting cycles carried out.

It should be emphasized that, in the case of cutting processes using oxidizing gases, tungsten, although having a high evaporation temperature, of around 5660° C., cannot be used as an emissive element, as in the presence of oxygen it forms oxides with a low sublimination temperature, for example about 800° C. in the case of tungsten oxide of the W₃O₈ type, resulting in extremely rapid destruction of the electrode.

To try to solve this problem, it has been proposed to use a process with dual plasma gas injection, one gas being non-oxidizing and the other oxidizing.

According to that process, a torch identical to that in FIG. 2 is used, in which the plasma chamber is supplied with a non-oxidizing plasma gas, such as nitrogen, while the second nozzle is supplied with an oxidizing plasma gas, in particular oxygen, as explained in document WO-A-99/53734.

Although that process does make it possible to obtain an appreciably longer lifetime than that obtained conventionally with hafnium electrodes in an oxidizing atmosphere, in practice it appears that the cutting quality and cutting performance that are obtained, owing to the creation of a plasma arc in a resulting nitrogen-oxygen mixture, are very similar to those obtained by a process with single injection of compressed air, that is to say very much inferior to those provided conventionally by single-oxygen-injection processes or by dual-injection processes using two oxidizing gases, for example oxygen between the electrode and a first nozzle and a nitrogen-oxygen mixture, the oxygen proportion of which is greater than that of air, between the first and second nozzles.

The problem that then arises is how to improve plasma cutting processes so as to be able to obtain cutting quality and cutting performance that are at least equal to those conventionally obtained with processes and torches using oxidizing plasma gases, that is to say of the type of processes with single injection of oxygen or else of the type of processes with dual injection of oxidizing gas, but ensuring a markedly longer lifetime of the electrode, preferably a lifetime at least twice that obtained conventionally with hafnium electrodes in an oxidizing atmosphere.

The solution provided by the invention is therefore a plasma arc cutting process for cutting a metal workpiece, in which a dual-gas-flow torch fitted with an electrode with an emissive insert is used, the said torch delivering a central gas stream and an annular gas stream, the said annular stream being delivered peripherally to the central gas stream, characterized in that the central gas stream contains a hydrogen-nitrogen mixture and the peripheral gas stream contains carbon dioxide.

The hydrogen-nitrogen mixture may be prepared beforehand in the desired proportions, for example in a form stored in gas bottles or in larger-volume tanks, or else it may be prepared on site, depending on the requirements, starting from “pure” gases that are mixed in the desired proportions by means of a gas mixer placed, for example, upstream of the cutting torch, connected to the “pure” gas bottles and controlled by a programmable controller.

Depending on the case, the process of the invention may comprise one or more of the following technical features:

the peripheral gas stream contains at least 50% carbon dioxide, preferably 80 to 100% carbon dioxide, by volume;

the central gas stream contains 1.5 to 60% hydrogen, preferably 4 to 10% hydrogen, by volume;

the central gas stream contains 1.5 to 60% hydrogen by volume, and nitrogen for the balance;

the emissive insert is made of tungsten or an alloy containing predominantly tungsten;

the electrode is made of copper or a copper alloy, in particular a copper-tellurium or copper-chromium-zirconium alloy;

he workpiece to be cut is made of structural steel, stainless steel or an aluminium alloy, preferably structural steel;

it furthermore includes the steps of:

(a) introducing a first gas stream between a first nozzle of the torch and the electrode so as to obtain the central gas stream,

(b) generating an electric arc on the electrode with the emissive insert,

(c) introducing a second gas stream between a second nozzle of the torch and the first nozzle so as to obtain the annular gas stream, it being possible for step (c) to be before or after step (b),

(d) delivering the central gas stream and the annular gas stream along the direction of a workpiece to be cut, in the form of a plasma arc jet containing the central and annular gas streams, and the electric arc and

(e) piercing and/or cutting the workpiece by means of the plasma arc jet of step (d);

the flow rate and the pressure of the central gas stream and of the peripheral annular gas stream are chosen or adjusted according to the thickness to be cut.

The invention also relates to a plasma cutting unit comprising:

a dual-gas-flow torch fitted with an electrode with an emissive insert, a first nozzle placed around the electrode, forming a plasma chamber with the said electrode, a second nozzle placed coaxially with the first nozzle and forming an internozzle space with the said first nozzle;

a first gas source containing a hydrogen-nitrogen mixture in fluid communication with the plasma chamber so as to be able to supply the said plasma chamber with the said gas mixture based on hydrogen and nitrogen; and

a second gas source containing carbon dioxide in fluid communication with the internozzle space so as to be able to supply the internozzle space with the said gaseous carbon dioxide.

The process of the invention, employing a plasma cutting torch of the type with dual plasma-gas injection, is shown schematically in FIG. 3.

FIG. 3 shows schematically a dual-flow plasma cutting torch 23 comprising an electrode 24, made of copper or a copper alloy, provided at its downstream end with an emissive insert 25, made of tungsten, a first nozzle 26 with a first gas inlet passage 28 for supplying a non-oxidizing first plasma gas, namely a nitrogen-hydrogen-mixture (containing 1.5 to 60 vol % hydrogen), a second nozzle 27 and a second gas inlet passage 29 for supplying an oxidizing second plasma gas, such as carbon dioxide (CO₂) or a gas mixture containing at least 50% carbon dioxide.

The plasma arc 30 formed on the emissive insert 25 extends through the outlet orifices of the nozzles 26 and 27 from the electrode 24 to the workpiece (not shown) located beneath.

The insert is preferably of cylindrical shape with a flat end flush with the end of the copper or copper alloy electrode. It has a length of 3 mm to 10 mm and a diameter of 1 mm to 5 mm, depending on the intensity of the plasma arc current. The emissive insert may also be formed from a bar sharpened into a point that projects from the end of the copper or copper alloy electrode body.

The hydrogen-nitrogen mixture is injected, via the first gas inlet passage 28, into the space lying between the electrode 24 and the first nozzle 26, this space generally being called the plasma chamber.

This H₂/N₂ mixture firstly has the effect of constricting the plasma arc right at the cathode arm root on the emissive insert 25 and of making it more stable than in pure nitrogen, and secondly has the effect of increasing heat transfer to the workpiece and thus of increasing the performance of the plasma arc.

The H₂/N₂ mixture is delivered by the torch in the form of a central stream of plasma gas containing not only the gas but also the electric arc, this central plasma stream being in the form of a plasma arc column.

The stream of carbon dioxide, injected via the passage 29, into the space lying between the first nozzle 26 and the second nozzle 27, also called the internozzle space, has, owing to its physical properties, firstly the effect of constricting the plasma arc by heat exchange with the central H₂/N₂-based stream containing the arc, and thus allowing a high current density in the second nozzle by extending the double-arc formation limit, and secondly the effect of releasing oxygen atoms upon partial dissociation in the plasma arc.

Such a release of oxygen atoms is beneficial as these atoms, on the one hand, fluidify the molten metal by reducing the surface tensions and, on the other hand, provide to a certain extent a thermal contribution by oxycombustion of the iron contained in the workpiece.

The second gas stream containing carbon dioxide is delivered peripherally to the first, central gas stream, that is to say so as to form a kind of annular sheet around the central stream.

As a result, the process of the invention provides cutting qualities and speeds at least equal to those obtained by conventional processes of equivalent electrical power, but with an additional advantage, namely that of resulting in electrode lifetimes that are more than twice those obtained hitherto with conventional processes of the type with a hafnium electrode in an oxidizing atmosphere, and this results in an increase in the productivity of plasma cutting machines by significantly reducing their shut-down time for changing an electrode, and in a reduction in the operating cost, by substantially reducing the number of electrodes needed for production.

### EXAMPLE

A plasma cutting torch, with the reference OCP 150 sold by La Soudure Autogène Fran [symbol] aise, was equipped with two coaxial nozzles, as shown in FIG. 3, with an electrode made of a copper alloy, fitted with a tungsten insert, and was then subjected to a succession of cutting sequences until the insert and/or the electrode were extremely worn.

The plasma cutting gas employed in these trials was formed from a central stream containing 10% hydrogen and 90% nitrogen (in % by volume) and an annular stream of pure carbon dioxide.

The material to be worked was a plate of structural steel 10 mm in thickness. The cutting current was 120 amps.

These trials have shown that an electrode according to the invention has a lifetime of around 10 hours with 1250 striking operations, which corresponds to 2.5 times the lifetime of electrodes with a pure hafnium insert under similar working conditions.

1-10. (canceled).

11. An apparatus for cutting a metal workpiece, comprising:
a) a dual-gas-flow torch;
b) said torch comprising an electrode with an emissive insert;
c) said torch comprising a gas delivery system;
d) said gas delivery system comprising a central gas stream and an annular gas stream; and
e) said annular stream being delivered peripherally to said central gas stream, wherein said central gas stream contains a hydrogen-nitrogen mixture and said peripheral gas stream contains carbon dioxide.

12. The apparatus according to claim 11, wherein said peripheral gas stream contains at least about 50% carbon dioxide, by volume.

13. The apparatus according to claim 12, wherein said peripheral gas stream contains at least about 80% to about 100% carbon dioxide, by volume.

14. The apparatus according to claim 11, wherein said central gas stream contains between about 1.5% and about 60% hydrogen, by volume.

15. The apparatus according to claim 14, wherein said central gas stream contains between about 4% and about 10% hydrogen, by volume.

16. The apparatus according to claim 11, wherein said central gas stream contains between about 1.5% and 60% hydrogen by volume, and nitrogen for the balance.

17. The apparatus according to claim 11, wherein said emissive insert comprises tungsten or an alloy containing predominantly tungsten.

18. The apparatus according to claim 11, wherein said electrode comprises copper or a copper alloy.

19. The apparatus according to claim 18, wherein said electrode comprises copper-tellurium alloy or copper-chromium-zirconium alloy.

20. The apparatus according to claim 11, further comprising a workpiece to be cut.

21. The apparatus according to claim 20, wherein said workpiece to be cut comprises structural steel, stainless steel, or an aluminum alloy.

22. The apparatus according to claim 21, wherein said workpiece to be cut comprises structural steel.

23. A method of cutting a metal workpiece, comprising:
a) providing a workpiece to be cut;
b) providing a dual-gas-flow torch, said torch further comprising a first nozzle and a second nozzle, an electrode with an emissive insert, and a gas delivery system, said gas delivery system further comprising a central gas stream and an annular gas stream, said annular stream being delivered peripherally to said central gas stream, wherein said central gas stream contains a hydrogen-nitrogen mixture and said peripheral gas stream contains carbon dioxide;
c) introducing a first gas stream between said first nozzle and said electrode so as to obtain said central gas stream;
d) generating an electric arc on said electrode with said emissive insert;
e) introducing a second gas stream between said second nozzle and said first nozzle so as to obtain said annular gas stream;
f) delivering said central gas stream and said annular gas stream to the surface of said workpiece, in the form of a plasma arc jet containing said central and annular gas streams, and said electric arc; and
g) cutting said workpiece by means of said plasma arc jet.

24. The method according to claim 23, wherein step e) is performed prior to step d).

25. The method according to claim 23, wherein step e) is performed subsequent to step d).

26. The method according to claim 23, wherein the flow rate and the pressure of said central gas stream, and the flowrate and the pressure of said peripheral annular gas stream are adjusted according to the thickness of said workpiece.

27. A plasma cutting unit comprising:
a) a dual-gas-flow torch, said torch comprising an electrode with an emissive insert, a first nozzle placed around said electrode, forming a plasma chamber with said electrode, a second nozzle placed coaxially with said first nozzle and forming an internozzle space with said first nozzle;
b) a first gas source containing a hydrogen-nitrogen mixture in fluid communication with said plasma chamber, supplying said plasma chamber with said hydrogen-nitrogen; and
c) a second gas source containing carbon dioxide in fluid communication with said internozzle space, supplying said internozzle space with said gaseous carbon dioxide.
